(19) United States
(12) Patent Application Publication
(10) Pub. No.: US 2025/0327767 A1
(43) Pub. Date: Oct. 23, 2025

(54) A SENSOR ARRANGEMENT COMPRISING A SENSOR PROBE, A SENSOR HOUSING AND A FLUID PATH CONNECTION BLOCK

(71) Applicant: CYTIVA SWEDEN AB, Uppsala (SE)

(72) Inventors: Klas Marteleur, Uppsala (SE); Johan Alriksson, Uppsala (SE)

(21) Appl. No.: 18/852,474

(22) PCT Filed: Apr. 6, 2023
(86) PCT No.: PCT/EP2023/059251

§ 371 Date: Sep. 29, 2024

(30) Foreign Application Priority Data
Apr. 14, 2022 (GB) 2205564.4

(51) Int. Cl. G01N 27/28; G01N 27/30

(52) U.S. Cl. CPC G01N 27/283; G01N 27/302

(57) ABSTRACT

A sensor arrangement (1: 1′: 1″) configured for being connected in a fluid path of a system for measuring at least one property of fluid transferred through the fluid path. Said sensor arrangement comprises a fluid chamber (13) which is surrounding at least a part of a sensor probe (3) of the sensor arrangement. wherein said fluid chamber (13) can be moved along the sensor probe (3) into at least two different positions comprising a process position in which the sensor clement (5) in the sensor probe is extending outside the fluid (chamber 13) and a service position in which the sensor element (5) is surrounded by the fluid chamber (13). The sensor arrangement further comprises a fluid path connection block (21: 21′) comprising an internal fluid path (23) configured for connection to the fluid path of the system in which said sensor arrangement (1: 1′: 1″) is to be used. The fluid path connection block (21: 21′) is configured to receive the sensor probe (3) of the sensor arrangement and comprises a fluid chamber closing (part 27) which together with a surrounding wall (14) of the fluid chamber (13) will close the fluid chamber (13) around the sensor element (5) when the fluid chamber is provided in the service position.

### TECHNICAL FIELD OF THE INVENTION

The present invention relates to a sensor arrangement configured for being connected in a fluid path of a system for measuring at least one property of a fluid transferred through the fluid path and to a method for calibrating and/or cleaning a sensor element in such a sensor arrangement.

### BACKGROUND

Measuring properties, such as chemical or physical process variables, in a fluid in a process system is performed by use of different types of sensors. Some sensors, such as for example pH sensors, need regular cleaning and calibration. One possibility is to remove the sensor from the process system and perform the needed service before the sensor is returned into position in the process system. Retractable sensor assemblies are also provided in which a sensor probe can be retracted into a service chamber in the sensor assembly during service. One such a retractable sensor assembly is disclosed in U.S. Pat. No. 9,228,863. A problem with such a retractable sensor assembly is that a sensor probe of the sensor assembly needs space outside the process system such that it can be retracted. Furthermore, the sensor probe needs to be provided with a plug in the end of the sensor probe which plug is arranged for closing the entrance into the process fluid container when the sensor has been retracted. Such a plug needs space within the process fluid container during sensor measuring and may disturb a fluid flow if the process fluid container where a property is measured is a fluid flow path.

### SUMMARY

An object of the present invention is to provide an improved sensor arrangement.

A further object is to provide a sensor arrangement which is suitable for connection in a fluid flow path.

This is achieved by a sensor arrangement and by a method according to the independent claims.

According to one aspect of the invention a sensor arrangement configured for being connected in a fluid path of a system for measuring at least one property of fluid transferred through the fluid path is provided, said sensor arrangement comprising:
an elongated sensor probe comprising a sensor element in an end portion of the sensor probe;
a probe housing which is connected to the sensor probe such that the sensor probe is protruding through the probe housing, said probe housing comprising:
   a fluid chamber which is surrounding at least a part of said sensor probe, wherein said fluid chamber is arranged in relation to said sensor probe such that the fluid chamber can be moved along the sensor probe into at least two different positions comprising a process position in which the sensor element in the sensor probe is extending outside the fluid chamber and a service position in which the sensor element is surrounded by the fluid chamber;
   a first port connected to the fluid chamber and configured for being connected to an external fluid providing device and/or an external suction device; and
   a second port connected to the fluid chamber and configured for allowing air to pass in and out from the fluid chamber; and
a fluid path connection block comprising an internal fluid path having an inlet and an outlet configured for connection to the fluid path of the system in which said sensor arrangement is to be used, said fluid path connection block further comprising a receiving unit for receiving the probe housing and the sensor probe such that the sensor element is positioned in the internal fluid path of the fluid path connection block, said fluid path connection block further comprising a fluid chamber closing part which together with a surrounding wall of the fluid chamber will close the fluid chamber around the sensor element when the fluid chamber is provided in the service position.

According to another aspect of the invention a probe housing configured to be used in a sensor arrangement as described above is provided.

According to another aspect of the invention a method for performing a service process of a sensor element in a sensor arrangement according to the invention, when said sensor arrangement is connected to a fluid path of a system, is provided. Said method comprises the steps of:
a) moving the fluid chamber into the service position;
b) providing a service fluid into the fluid chamber from an external fluid providing device via the first port and performing the service process;
c) removing the service fluid from the fluid chamber by an external suction device via the first port;
d) possibly repeating steps b) and c) during the service process;
e) moving the fluid chamber back to the process position.

Hereby a sensor arrangement is provided which comprises a fluid path connection block by which said sensor arrangement can be conveniently connected directly in a fluid flow path for measuring at least one property of the fluid. A fluid chamber of the sensor arrangement can be provided in a process position and a service position while the sensor probe is kept in a fixed position. Hereby no extra space is needed outside the process system. In the process position of the fluid chamber the sensor element of the sensor probe is provided within the fluid flow and measuring is possible. In the service position of the fluid chamber the surrounding wall and the fluid chamber closing part together closes the fluid chamber around the sensor element whereby the sensor element can be calibrated or cleaned easily by the addition of a service fluid into the fluid chamber via the first port. Hereby easy and efficient service of the sensor element can be provided and hereby a user friendly and easily handled sensor arrangement is achieved. By using a fluid chamber closing part, which is provided in the internal fluid path of the fluid path connection block, for sealing the fluid chamber around the sensor element together with the surrounding wall of the fluid chamber when the fluid chamber is provided in the service position, a sensor arrangement which is suitable for use in a fluid flow path is achieved.

In one embodiment of the invention said service process is one or more of a calibration, a cleaning or a storing process and where the service fluid is one or more of a calibration, a cleaning or a storing fluid.

In one embodiment of the invention said fluid chamber closing part comprises a protruding plug provided in the internal fluid path of the fluid path connection block around which said surrounding wall of the fluid chamber fits and seals when the fluid chamber is provided in the service position.

In one embodiment of the invention the first port is connected to a first end part of the fluid chamber, which first end part is provided in the end of the fluid chamber provided closest to the sensor element, whereby said first port comprises an extended tube which connects the first end part of the fluid chamber with a port connector of the first port. Hereby a service fluid can be both added to and removed from the fluid chamber efficiently via said extended tube. In one embodiment of the invention said sensor element is configured for measuring pH.

In one embodiment of the invention the internal fluid path of the fluid path connection block allows fluid to pass between the inlet and the outlet of the internal fluid path in both the process position and the service position of the fluid chamber. Hereby, fluid can pass through the internal fluid path despite the position of the fluid chamber and therefore the internal fluid path can be cleaned by for example sodium hydroxide when the fluid chamber is in a service position, thereby protecting the sensor element from the sodium hydroxide. Hereby, in such an embodiment, cleaning of the fluid path and the internal fluid path of the fluid path connection block can be performed without removing the sensor arrangement from the system.

In another embodiment of the invention the fluid chamber seals the internal fluid path of the fluid path connection block such that a fluid is prevented from passing between the inlet and the outlet of the internal fluid path when the fluid chamber is provided in the process position.

In such an embodiment a number of valves in the system can be limited.

In one embodiment of the invention the sensor element can be both calibrated, cleaned and stored in a service fluid provided to the fluid chamber via the first port when said fluid chamber is provided in the service position.

In one embodiment of the invention the surrounding wall comprises a sealing device which is configured for sealing to the fluid chamber closing part in the service position and around the sensor probe in the process position.

In one embodiment of the invention said probe housing is at least partially 3-d printed.

In one embodiment of the invention said second port is connected to a second end part of the fluid chamber, which second end part is the opposite end to the first end part of the fluid chamber. Hereby air can be efficiently removed via the second port.

In one embodiment of the invention said sensor probe is releasably provided in the probe housing.

### BRIEF DESCRIPTION OF THE DRAWINGS

FIG. 1a is a cross section view of a sensor arrangement according to one embodiment of the invention in a process position.

FIG. 1b is the same as FIG. 1a but in a perspective view.

FIG. 2a is a cross section view of the same sensor arrangement as shown in FIGS. 1a and 1b in a service position.

FIG. 2b is the same as FIG. 2a but in a perspective view.

FIG. 3a is a perspective view of a sensor arrangement according to another embodiment of the invention in a service position.

FIG. 3b is a cross section of the sensor arrangement as shown in FIG. 3a in service position.

FIG. 4 is a cross section view of a sensor arrangement according to another embodiment of the invention in a service position.

FIG. 5 is a flow chart of a method according to one embodiment of the invention.

### DETAILED DESCRIPTION OF EMBODIMENTS

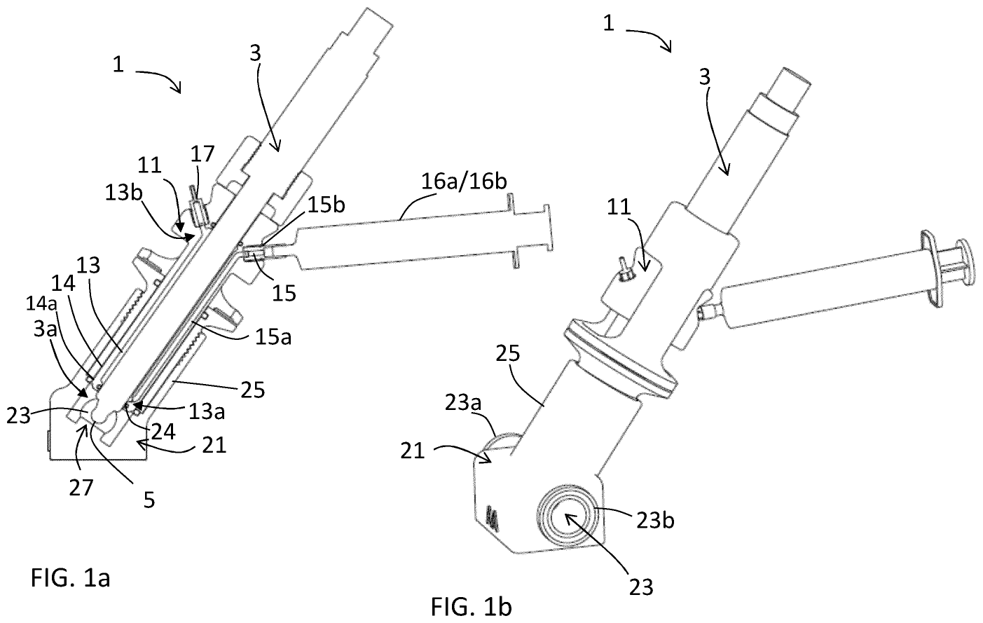

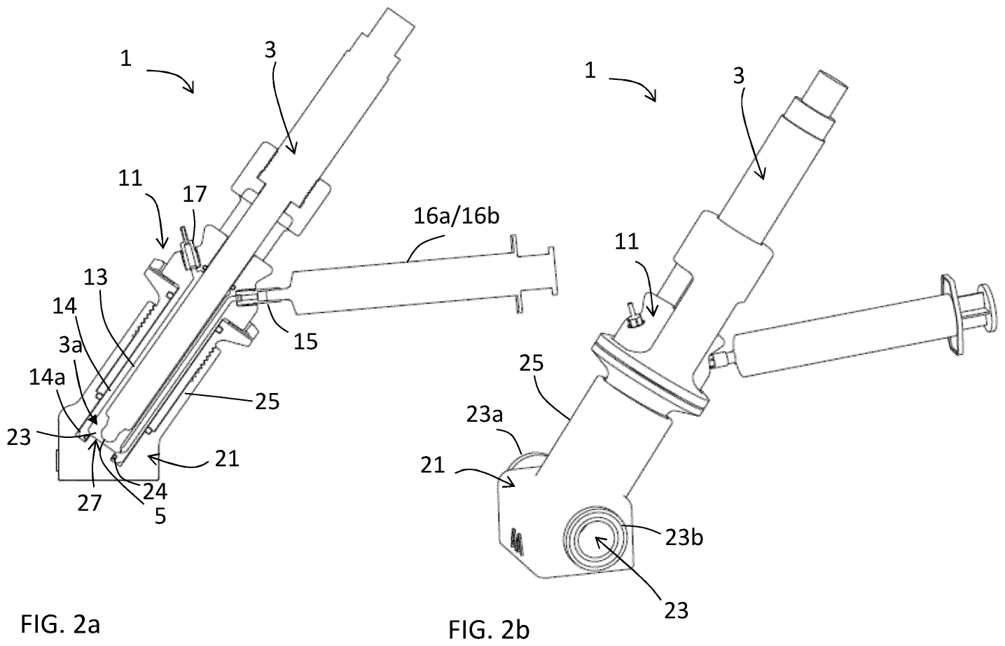

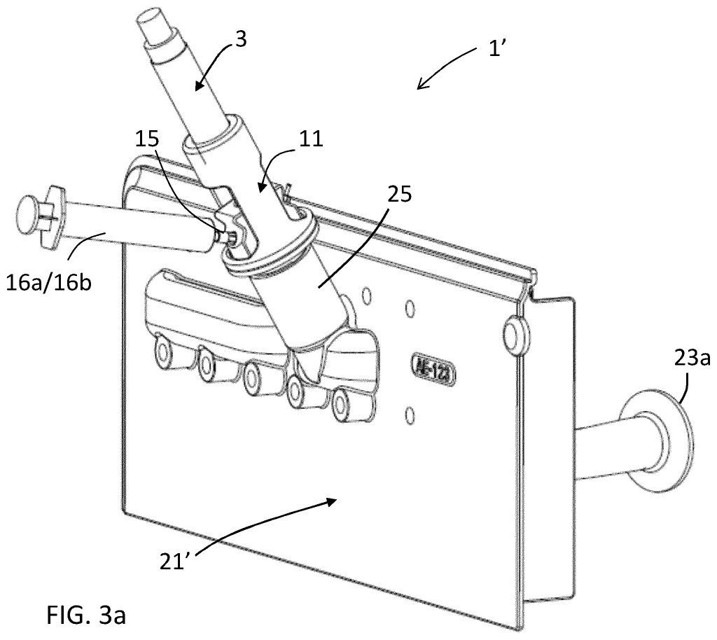

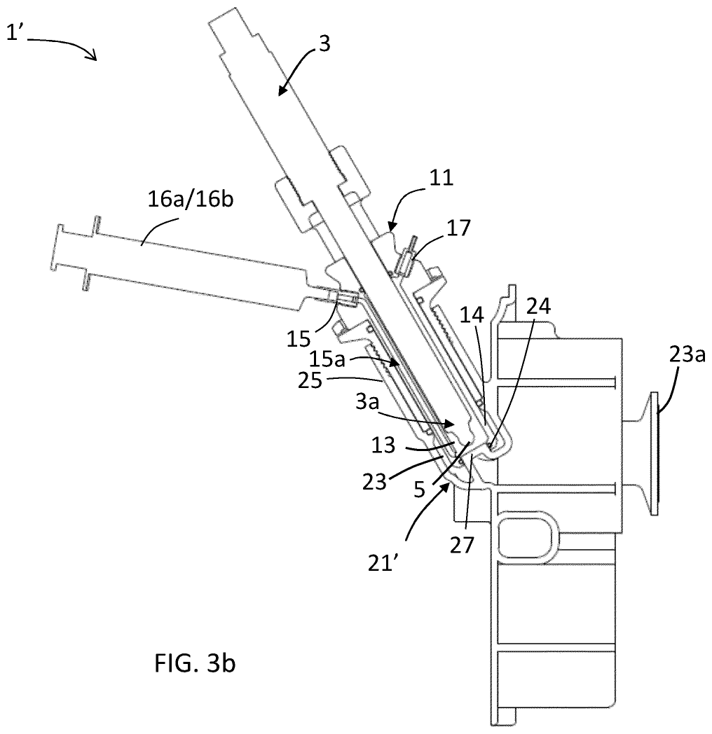

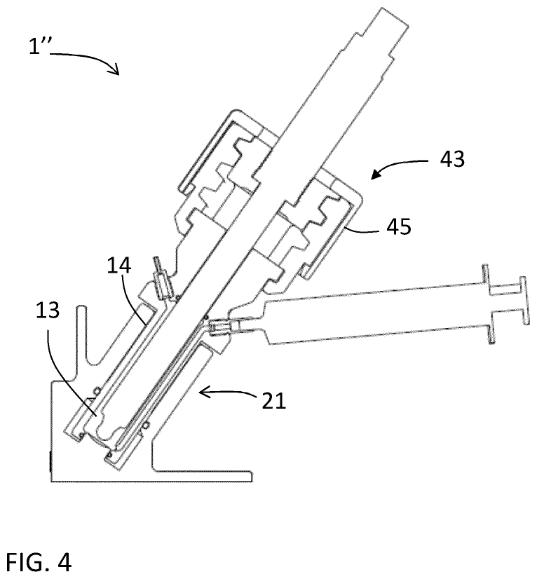

In FIGS. 1 and 2 a sensor arrangement 1 according to one embodiment of the invention is shown in two different positions. A process position is shown in Figures la and 1b and a service position is shown in FIGS. 2a and 2b. In FIGS. 3a and 3b a sensor arrangement 1′ according to another embodiment of the invention is shown in a service position. Many of the details are the same for both these embodiments and are therefore given the same or similar reference numbers and both embodiments will be described together with reference to all the drawings below. What differs between these two embodiments is that a fluid path connection block 21; 21′ of the sensor arrangements 1; 1′ comprise different components. The fluid path connection block 21′ of the sensor arrangement 1′ of FIGS. 3a and 3b comprises more parts, such as valves and additional flow paths whereby a fluid flow can be guided in different ways through the fluid path connection block 21′. For example, by control of valves (not shown) in the fluid path connection block 21′, the fluid flow can be guided via a sensor element 5 of the sensor arrangement 1′ or be guided to bypass the sensor element 5.

The sensor arrangement 1; 1′ according to both these embodiments of the invention is configured for being connected in a fluid path of a system for measuring at least one property of a fluid transferred through the fluid path. The system may be, or can include, a bioprocessing system, or a subsystem thereof. The fluid path connection block 21; 21′ according to both the embodiments of the invention as shown in FIGS. 1-3 can easily be connected directly in a fluid path of a process system, such as for example a bioprocess system (e.g. a chromatography system, bio-reactor system, fluid mixing system, filtration system (e.g. comprising tangential flow filters (TFF) or the like), fill and finish system, etc.). Hereby at least one property of the fluid can be measured by a sensor element 5 provided in the sensor arrangement 1; 1′.

The sensor arrangement 1; 1′ comprises an elongated sensor probe 3 comprising a sensor element 5 in an end portion 3a of the sensor probe 3. The sensor arrangement 1; 1′ comprises further a probe housing 11 which is connected to the sensor probe 3 such that the sensor probe 3 is protruding through the probe housing 11. The probe housing 11 comprises a fluid chamber 13 which is surrounding at least a part of said sensor probe 3, wherein said fluid chamber 13 is arranged in relation to said sensor probe 3 such that the fluid chamber 13 can be moved along the sensor probe 3 into at least two different positions comprising a process position in which the sensor element 5 in the sensor probe 3 is extending outside the fluid chamber 13 and a service position in which the sensor element 5 is surrounded by the fluid chamber 13. The probe housing 11 comprises further a first port 15 connected to the fluid chamber 13 and configured for being connected to an external fluid providing device 16a and/or an external suction device 16b. Hereby a service fluid, such as a calibration fluid, a cleaning fluid or a storage fluid can be provided into the fluid chamber 13 via the first port 15. The service fluid can then be sucked out from the fluid chamber 13 by an external suction device 16b connected to the first port 15. The probe housing 11 comprises further a second port 17 connected to the fluid chamber 13 and configured for allowing air to pass in and out from the fluid chamber 13. Possibly more ports can be provided whereby fluid for example can be provided via one port and sucked out via another port. And possibly different types of service fluids can be added via different ports. Another possibility is to connect valves to the first port 15 in order to allow multiple uses of the first port 15.

The sensor arrangement 1; 1′ comprises furthermore a fluid path connection block 21; 21′ as described above. Said fluid path connection block 21; 21′ comprises an internal fluid path 23 having an inlet 23a and an outlet 23b (only inlet 23a can be seen in FIG. 3a) configured for connection to a fluid path of a system. The fluid path connection block 21; 21′ comprises further a receiving unit 25 for receiving the probe housing 11 and the sensor probe 3 such that the sensor element 5 is positioned in the internal fluid path 23 of the fluid path connection block 21; 21′. The fluid path connection block 21; 21′ comprises furthermore a fluid chamber closing part 27 which together with a surrounding wall 14 of the fluid chamber 13 will close the fluid chamber 13 around the sensor element 5 when the fluid chamber 13 is provided in the service position. Hereby a service fluid, such as for example a calibration fluid, a cleaning fluid or a storage fluid can be provided into the fluid chamber 13, when the fluid chamber 13 is provided in the service position, without leaking out into the fluid path of the system in which said sensor arrangement 1; 1′ is connected.

In both embodiments as shown in FIGS. 1-3 the fluid chamber closing part 27 comprises a protruding plug provided in the internal fluid path 23 of the fluid path connection block 21; 21′ around which said surrounding wall 14 of the fluid chamber 13 fits and seals when the fluid chamber 13 is provided in the service position.

In some embodiments of the invention the sensor element 5 is configured for measuring pH, i.e. said sensor element 5 is a pH sensor. A pH sensor needs to be calibrated regularly and between different batches to function properly. It also needs to be cleaned regularly and between different batches/processes. It is also often necessary to store the pH sensor away from the process fluid at times when no measuring is necessary. By the present invention both calibration, cleaning and storing can be provided within the sensor arrangement 1; 1′ without the need to remove the sensor probe 3 for treatment outside the system. Hereby handling of the system is facilitated.

Suitably the surrounding wall 14 comprises a sealing device 24 which is configured for sealing around the fluid chamber closing part 27 in the service position and around the sensor probe 3 in the process position. The sealing device 24 can be for example an O-ring or a gasket. In another embodiment a sealing device can instead be provided at the end of the surrounding wall 14 and be configured for sealing towards a flat surface in the internal fluid path 23 of the fluid path connection block 21; 21′. In such an embodiment the fluid chamber closing part 27 does not comprise a protruding plug as shown in FIGS. 1a, 2a and 3b but comprises rather a part of a flat inner wall surface of the internal fluid path 23 of the fluid path connection block 21; 21′. The sealing device is hereby in such an embodiment pressed between the end of the surrounding wall 14 and the inner wall surface and hereby the fluid chamber 13 is closed around the sensor element 5 when the fluid chamber 13 is provided in the service position. The first port 15 is in some embodiments (as shown in FIGS. 1-3) connected to a first end part 13a of the fluid chamber 13, which first end part 13a is provided in the end of the fluid chamber 13 provided closest to the sensor element 5. The first port 15 comprises an extended tube 15a which is connecting the first end part 13a of the fluid chamber 13 with a port connector 15b of the first port 15. Hereby the port connector 15b of the first port 15 can be positioned at a distance from the first end part 13a of the fluid chamber 13 and still be connected directly to the first end part 13a of the fluid chamber 13 which may be suitable for providing the service fluid to and removing the service fluid from the fluid chamber efficiently. Furthermore, the port connector 15b can be positioned outside the receiving unit 25 of the fluid path connection block 21; 21′ whereby access to the port connector 15b for a user is improved.

The second port 17 can be connected to a second end part 13b of the fluid chamber 13, which second end part 13b is the opposite end to the first end part 13a of the fluid chamber 13. Hereby, air can efficiently be released through the second port 17 when a service fluid is added via the first port 15 and air can enter into the fluid chamber via the second port 17 when the service fluid is sucked out via the first port 15. One or more check valves can possibly be provided to the second port 17 for allowing filtration of air and possibly also removal of fluid. For best efficiency when removing the service fluid from the fluid chamber 13 the sensor arrangement 1; 1′ can be tilted somewhat, for example 5-70° from a vertical plane towards the side of the sensor arrangement 1; 1′ where the extended tube 15a enters into the first end part 13a of the fluid chamber 13. Hereby all service fluid can efficiently be sucked out via the first port 15.

The surrounding wall 14 of the fluid chamber 13 can in some embodiments (as shown in FIGS. 1-3) comprise an end portion 14a having a smaller inner circumference than the rest of the surrounding wall in order to close the fluid chamber 13 at its first end 13a towards the sensor probe 3 in the process position of the fluid chamber 13. The end portion 14a of the surrounding wall 14 can comprise said sealing device 24 whereby the sealing device 24 seals against an outer surface of the sensor probe 3 in the process position of the fluid chamber 13. Alternatively, instead of an end portion 14a with a smaller inner circumference, the sealing device 24 can be bigger. Furthermore, the sealing device 24 seals against the fluid chamber closing part 27 in the service position as discussed above. The end portion 14a of the surrounding wall 14 is the end of the surrounding wall 14 which is closest to the first end part 13a of the fluid chamber 13. Hereby a circumference geometry of the fluid chamber closing part 27 corresponds in some embodiments to a circumference geometry of the sensor probe 3. The circumference geometry is often circular and the diameter of the fluid chamber closing part 27 and the diameter of the sensor probe 3 are hereby suitably the same. Hereby the surrounding wall 14 will close the fluid chamber 13 against an outer surface of the sensor probe 3 in the process position and against the fluid chamber closing part 27 in the service position. However, in another embodiment as described above the fluid chamber closing part 27 needs not to be a protruding plug but can instead be a flat surface of an inner wall of the internal fluid path.

In some embodiments of the invention, the internal fluid path 23 of the fluid path connection block 21; 21′ allows fluid to pass between the inlet 23a and the outlet 23b of the internal fluid path 23 in both the process position and the service position of the fluid chamber 13. Hereby, in such embodiments of the invention, an outer circumference of the surrounding wall 14 of the fluid chamber 13 is at least in some positions smaller than an inner circumference of the internal fluid path 23 such that fluid can pass by the fluid chamber 13 in the internal fluid path 23 of the fluid path connection block 21; 21′. This can be seen in the embodiment as shown in FIG. 3b. However, this can also be provided in the embodiment as shown in FIGS. 1 and 2.

In other embodiments of the invention, the fluid chamber 13 seals the internal fluid path 23 of the fluid path connection block 21; 21′ such that a fluid is prevented from passing between the inlet 23a and the outlet 23b of the internal fluid path 23 when the fluid chamber 13 is provided in the process position. The surrounding wall 14 of the fluid chamber 13 is hereby sealed towards an internal surface in the internal fluid path 23, possibly via a sealing device.

In some embodiments of the invention the probe housing 11 and possibly also the fluid path connection block 21; 21′ are 3-d printed. A resin based 3-d printing technology, such as SLA or CLIP, may be advantageous, especially for production of the probe housing. Powder based 3-d printing technology, such as SLS, is another alternative. An alternative method for manufacturing of the probe housing 11 can be to use diffusion bonding whereby the probe housing in such an example is provided in two halves which can be machined by milling. Then the two halves are bound together by diffusion bonding. The design and materials used for the sensor arrangement according to the invention are preferably suitable for sterilization.

Furthermore, the sensor arrangement should suitably work for pressures up to at least 6 bar or up to 10 bar.

The sensor probe 3 may be releasably provided in the probe housing 11. In both embodiments as shown in FIGS. 1-3 the sensor probe 3 and the probe housing 11 are releasable connected by threads, however, other alternatives for the connection are possible. Hereby the sensor probe 3 can be removed for exchange or external maintenance. FIG. 4 is a cross section view of a sensor arrangement 1″ according to another embodiment of the invention in a service position. The only important difference in this embodiment is that there is a threaded mechanism 43 provided for moving the fluid chamber 13 between the service position and the process position. The threaded mechanism 43 is connected to the surrounding wall 14 of the fluid chamber 13 such that a user of the sensor arrangement 1″ can rotate a cap 45 of the threaded mechanism 43 in one direction for moving the fluid chamber 13 to the service position and in the other direction for moving the fluid chamber 13 to the process position. The fluid path connection block 21 in FIG. 4 can be the same as shown in FIGS. 1 and 2, however in this example the design is a bit different with two extending flanges. The function and the features which are important for the invention are however the same as those shown for the fluid path connection block 21 of FIGS. 1 and 2.

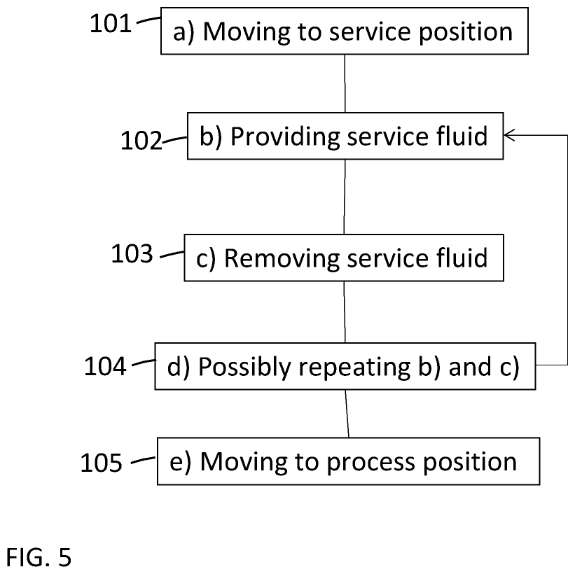

In FIG. 5 a flow chart of a method according to one embodiment of the invention is shown. The method is a method for performing a service process of a sensor element 5 in a sensor arrangement 1; 1′ according to the invention, when said sensor arrangement is connected to a fluid path of a system. The method comprises the steps of:
a) Moving 101 the fluid chamber 13 into the service position. When service, for example a calibration or a cleaning, of the sensor element is needed the fluid chamber 13 is moved to the service position as discussed above. Hereby the fluid chamber 13 will be closed around the sensor element 5 by help of the fluid chamber closing part 27.
b) Providing 102 a service fluid into the fluid chamber 13 from an external fluid providing device 16a via the first port 15 and performing the service process. If the service is a calibration, the service fluid is a calibration fluid and the service process is a calibration process. It can also be a cleaning fluid or a storage fluid.
c) Removing 103 the service fluid from the fluid chamber 13 by an external suction device 16b via the first port 15. Thanks to the extended tube 15a provided to the first end part 13a of the fluid chamber and thanks to the tilted position of the sensor arrangement 1; 1 according to the embodiments as shown in FIGS. 1-3 all service fluid will be efficiently removed from the fluid chamber 13.
d) Possibly repeating 104 steps b (102) and c (103) during the service process. Possibly a calibration process needs another calibration fluid to be provided and possibly also cleaning fluid before the calibration process is ready.
e) Moving 105 the fluid chamber 13 back to the process position, whereby measuring of at least one property of a fluid transferred through the fluid path in which the sensor arrangement 1; 1′ is provided can continue.

In various embodiments, one or more component part may be formed of various materials. Such materials may be compatible with bioprocessing operations and can be readily sterilized without compromising their integrity. For example, parts may be formed using one or more of: a polymer material and/or a strengthened polymer material, polypropylene (PP), polyamide (PA) and/or Polyoxymethylene (POM), etc.

1. A sensor arrangement (1; 1′; 1′) configured for being connected in a fluid path of a system for measuring at least one property of fluid transferred through the fluid path, said sensor arrangement comprising:
an elongated sensor probe (3) comprising a sensor element (5) in an end portion (3a) of the sensor probe (3);
a probe housing (11) which is connected to the sensor probe (3) such that the sensor probe (3) is protruding through the probe housing (11), said probe housing (11) comprising:
a fluid chamber (13) which is surrounding at least a part of said sensor probe (3), wherein said fluid chamber (13) is arranged in relation to said sensor probe (3) such that the fluid chamber (13) can be moved along the sensor probe (3) into at least two different positions comprising a process position in which the sensor element (5) in the sensor probe (3) is extending outside the fluid chamber (13) and a service position in which the sensor element (5) is surrounded by the fluid chamber (13);
a first port (15) connected to the fluid chamber (13) and configured for being connected to an external fluid providing device (16a) and/or an external suction device (16b); and
a second port (17) connected to the fluid chamber (13) and configured for allowing air to pass in and out from the fluid chamber (13); and
a fluid path connection block (21; 21′) comprising an internal fluid path (23) having an inlet (23a) and an outlet (23b) configured for connection to the fluid path of the system in which said sensor arrangement is to be used, said fluid path connection block (21; 21′) further comprising a receiving unit (25) for receiving the probe housing (11) and the sensor probe (3) such that the sensor element (5) is positioned in the internal fluid path (23) of the fluid path connection block (21; 21′), said fluid path connection block (21) further comprising a fluid chamber closing part (27) which together with a surrounding wall (14) of the fluid chamber (13) will close the fluid chamber (13) around the sensor element (5) when the fluid chamber (13) is provided in the service position.

2. The sensor arrangement (1; 1′; 1′) according to claim 1, wherein said fluid chamber closing part (27) comprises a protruding plug provided in the internal fluid path (23) of the fluid path connection block (21; 21′) around which said surrounding wall (14) of the fluid chamber (13) fits and seals when the fluid chamber (13) is provided in the service position.

3. The sensor arrangement (1; 1′; 1′) according to any one of the preceding claims, wherein the first port (15) is connected to a first end part (13a) of the fluid chamber (13), which first end part (13a) is provided in the end of the fluid chamber (13) provided closest to the sensor element (5), whereby said first port (15) comprises an extended tube (15a) which connects the first end part (13a) of the fluid chamber (13) with a port connector (15b) of the first port (15).

4. The sensor arrangement (1; 1′; 1′) according to any one of the preceding claims, wherein said sensor element is configured for measuring pH.

5. The sensor arrangement (1; 1′; 1′) according to any one of the preceding claims, wherein the internal fluid path (23) of the fluid path connection block (21′) allows fluid to pass between the inlet (23a) and the outlet (23b) of the internal fluid path (23) in both the process position and the service position of the fluid chamber (13).

6. The sensor arrangement (1; 1′; 1′) according to any one of the claims 1-4, wherein the fluid chamber (13) seals the internal fluid path (23) of the fluid path connection block (21) such that a fluid is prevented from passing between the inlet (23a) and the outlet (23b) of the internal fluid path (23) when the fluid chamber (13) is provided in the process position.

7. The sensor arrangement (1; 1′; 1′) according to any one of the preceding claims, wherein in said service position of the fluid chamber (13) the sensor element (5) can be both calibrated, cleaned and stored in a service fluid provided to the fluid chamber (13) via the first port (15).

8. The sensor arrangement (1; 1′; 1′) according to any one of the preceding claims, wherein the surrounding wall (14) comprises a sealing device (24) which is configured for sealing to the fluid chamber closing part (27) in the service position and around the sensor probe (3) in the process position.

9. The sensor arrangement (1; 1′; 1′) according to any one of the preceding claims, wherein said probe housing (11) is at least partially 3-d printed.

10. The sensor arrangement (1; 1′; 1′) according to any one of the preceding claims, wherein said second port (17) is connected to a second end part (13b) of the fluid chamber (13), which second end part (13b) is the opposite end to the first end part (13a) of the fluid chamber (13).

11. The sensor arrangement (1; 1′; 1′) according to any one of the preceding claims, wherein said sensor probe (3) is releasably provided in the probe housing (11).

12. The sensor arrangement (1; 1′; 1′) according to any one of the preceding claims, wherein at least one part thereof comprises a polymer material and/or a strengthened polymer material, polypropylene (PP), polyamide (PA) and/or Polyoxymethylene (POM) and/or is sterilized.

13. The sensor arrangement (1; 1′; 1′) according to any one of the preceding claims, wherein the system is a bioprocessing system.

14. A probe housing (11) which is configured to be used in a sensor arrangement (1; 1′; 1″) according to any one of the preceding claims, wherein said probe housing is configured for being connected to the sensor probe (3) of the sensor arrangement such that the sensor probe (3) is protruding through the probe housing (11), said probe housing (11) comprising:
a fluid chamber (13) which is surrounding at least a part of said sensor probe (3), wherein said fluid chamber (13) is arranged in relation to said sensor probe (3) such that the fluid chamber (13) can be moved along the sensor probe (3) into at least two different positions comprising a process position in which the sensor element (5) in the sensor probe (3) is extending outside the fluid chamber (13) and a service position in which the sensor element (5) is surrounded by the fluid chamber (13);
a first port (15) connected to the fluid chamber (13) and configured for being connected to an external fluid providing device (16a) and/or an external suction device (16b); and
a second port (17) connected to the fluid chamber (13) and configured for allowing air to pass in and out from the fluid chamber (13),
wherein said probe housing (11) is configured to be received in the receiving unit (25) of the fluid path connection block (21; 21′) of the sensor arrangement (1; 1′; 1″) such that the sensor element (5) of the sensor probe (3) is positioned in the internal fluid path (23) of the fluid path connection block (21; 21′) and wherein a surrounding wall (14) of said fluid chamber (13) is configured to, together with the fluid chamber closing part (27) of the fluid path connection block (21), close the fluid chamber (13) around the sensor element when the fluid chamber (13) is provided in the service position.

15. A method for performing a service process of a sensor element (5) in a sensor arrangement (1; 1′) according to any one of the claims 1-13, when said sensor arrangement is connected to a fluid path of a system, said method comprising the steps of:
a) moving (101) the fluid chamber (13) into the service position;
b) providing (102) a service fluid into the fluid chamber (13) from an external fluid providing device (16a) via the first port (15) and performing the service process;
c) removing (103) the service fluid from the fluid chamber (13) by an external suction device (16b) via the first port (15);
d) possibly repeating (104) steps b) and c) during the service process;
e) moving (105) the fluid chamber (13) back to the process position.

16. The method according to claim 15, wherein said service process is one or more of a calibration, a cleaning or a storing process and where the service fluid is one or more of a calibration, a cleaning or a storing fluid.
